(19) United States
(12) Patent Application Publication
(10) Pub. No.: US 2003/0005811 A1
(43) Pub. Date: Jan. 9, 2003

(54) Mallet linkage for a bass drum

(76) Inventor: Wu-Hong Hsieh, Lu Chou City (TW)

Correspondence Address: Venable, Baetjer, Howard & Civiletti, LLP, Suite 1000, 1201 New York Avenue, N.W., Washington, DC, 20005-3917, US

(21) Appl. No.: 09/899,060

(22) Filed: Jul. 6, 2001

(51) Int. Cl. G10D 13/02

(52) U.S. Cl. 84/422.1

(57) ABSTRACT

A mallet linkage for a bass drum has a substantially trapezoid side-configuration and is eccentrically coupled to a striking mechanism for a bass drum. The mallet linkage is able to drive a mallet of the striking mechanism to engage the bass drum in an enhanced impact strength and improve the agility of the mallet.

### BACKGROUND OF THE INVENTION

1. Field of the Invention

The present invention relates to a mallet linkage, and more particularly to a mallet linkage for a bass drum which is able to enhance the agility and the impact strength of a mallet.

2. Description of Related Art

With reference to FIG. 6, a conventional striking mechanism for a bass drum is shown and includes a stand (60) and a cylindrical linkage (63) pivotally and centrally connected to the stand (60) by a shaft (64). A mallet (65) has a first end connected to the cylindrical linkage (63) and a second end mounted with a mallet head (66) for striking a bass drum (70) standing in front of the stand (60). The cylindrical linkage (63) is driven by a pedal (61) linked to the driving block (63) by a chain (62).

When striking the bass drum (70) with the mallet (65), a player (not shown) steps with a constant force on the pedal (61) to drive the mallet (65) by the connection of the chain (62) and the cylindrical linkage (63). However, due to the cylindrical configuration of the linkage (63), the linkage (63) provides a constant torque and the mallet head (66) approaches the bass drum (70) in a constant approaching speed relative to the constant force input on the pedal (61). The constant approaching speed is not efficient because the mallet head (66) performs better if the mallet head (66) can be accelerated before impacting the bass drum (70). Furthermore, after an impact, the mallet head (66) departs from the bass drum (70) in a constant departing speed relative to a constant return force on the pedal (61) from a return mechanism. The constant departing speed is not suitable because the mallet head (66) may not depart far enough to be ready for a subsequent repeat action. This insufficient return speed will decrease the agility of the mallet (65), for example, if a very rapid series of impacts on the bass drum (70) is required the mallet head does not reach its start point rapidly enough for the subsequent actuation.

To overcome the shortcomings, the present invention tends to provide an improved mallet linkage for a bass drum to mitigate or obviate the aforementioned problems.

### SUMMARY OF THE INVENTION

The objective of the present invention is to provide a mallet linkage for a bass drum which has a trapezoid side-configuration and is eccentrically disposed to accelerate and accelerate relative to a constant force input to enhance the impact force exerted onto the bass drum and improve the agility of a mallet.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a mallet linkage for a bass drum in accordance with the present invention;

FIG. 2 is a longitudinal side view of the mallet linkage;

FIG. 3 is a perspective view of a striking mechanism of a bass drum with the mallet linkage;

FIG. 4 is an operational, side view of the striking mechanism and a bass drum after a strike;

FIG. 5 is an operational, side view of the striking mechanism and the bass drum during a strike; and

FIG. 6 is a side view of a conventional striking mechanism.

### DETAILED DESCRIPTION OF THE PREFERRED EMBODIMENT

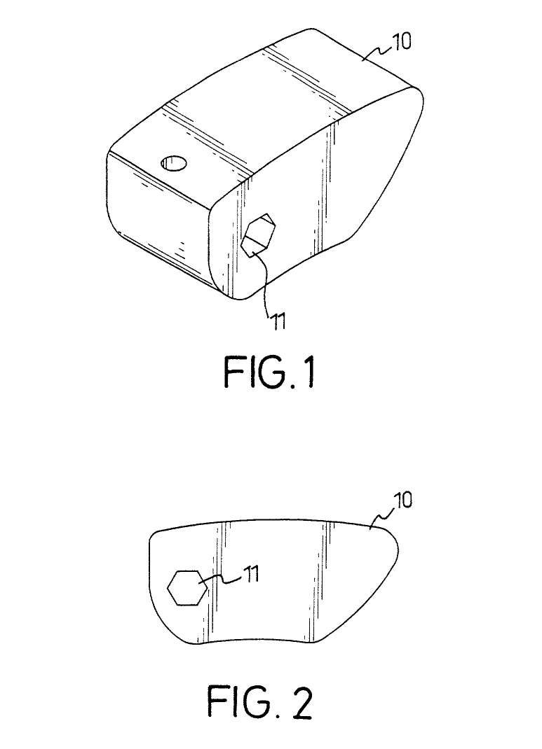

With reference to FIGS. 1 and 2, a mallet linkage (10) for a bass drum in accordance with the present invention has a substantially trapezoid side configuration with two end faces and two opposed sides faces. A first of the side faces is longer than the second side face, and both side faces have a common camber. A first of the end faces is substantially perpendicular to the side faces and the second end face is inclined to the first end face. The mallet linkage (10) has a polygonal through hole (11) eccentrically defined and communicating two longitudinal side surfaces of the mallet linkage (10).

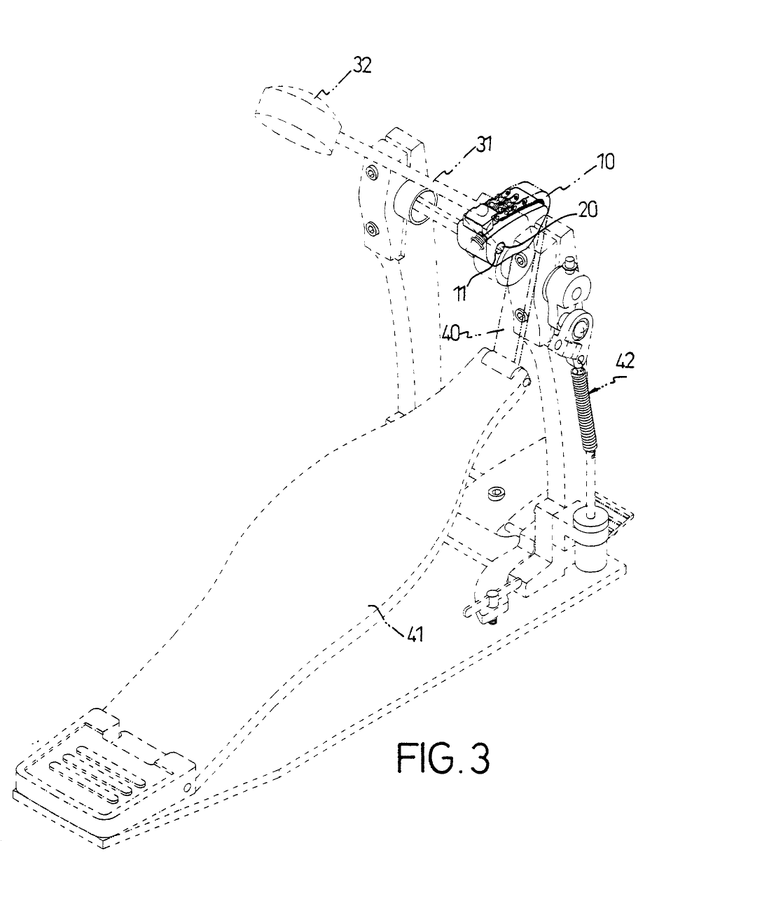

With reference to FIG. 3, a striking mechanism with the mallet linkage (10) is shown. A polygonal shaft (20) having a configuration corresponding to the polygonal through hole (11) extends through the through hole (11) and couples the mallet linkage (10) to a stand (30). A mallet (31) has an end connected to the mallet linkage (10) and another end mounted with a mallet head (32). A pedal (41) for a player to control actuation of the mallet (31) is disposed in a pre-actuated condition. The pedal (41) links to the mallet linkage (11) by a chain (40). A resilient member (42) is provided to generate retrieving resilience to the pedal (41) whereby once the pedal (41) is pushed down to a substantially horizontal lower limit the resilient member (42) returns the pedal (41) to its pre-actuated position.

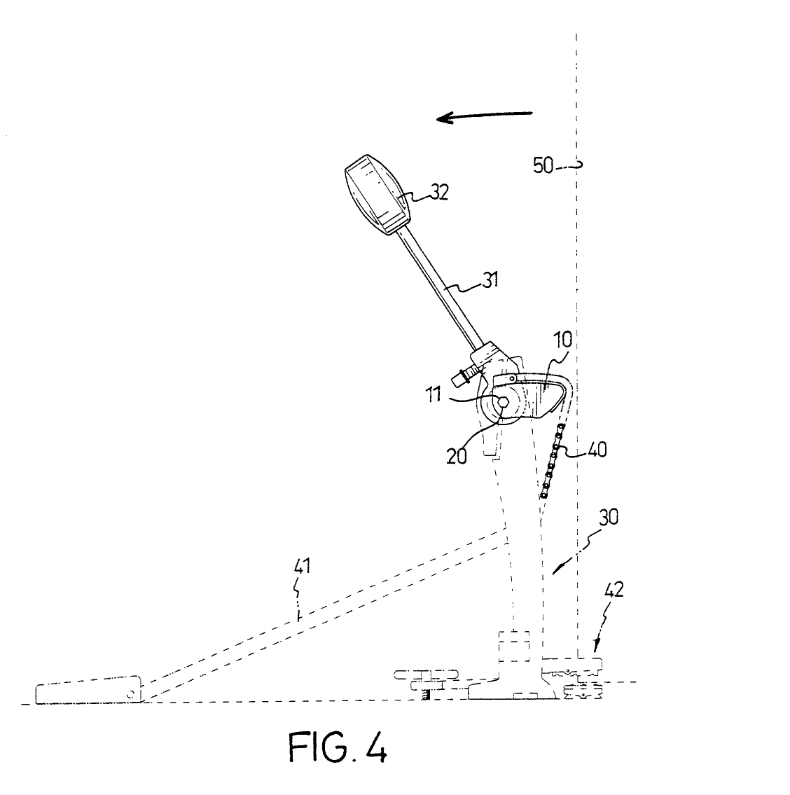

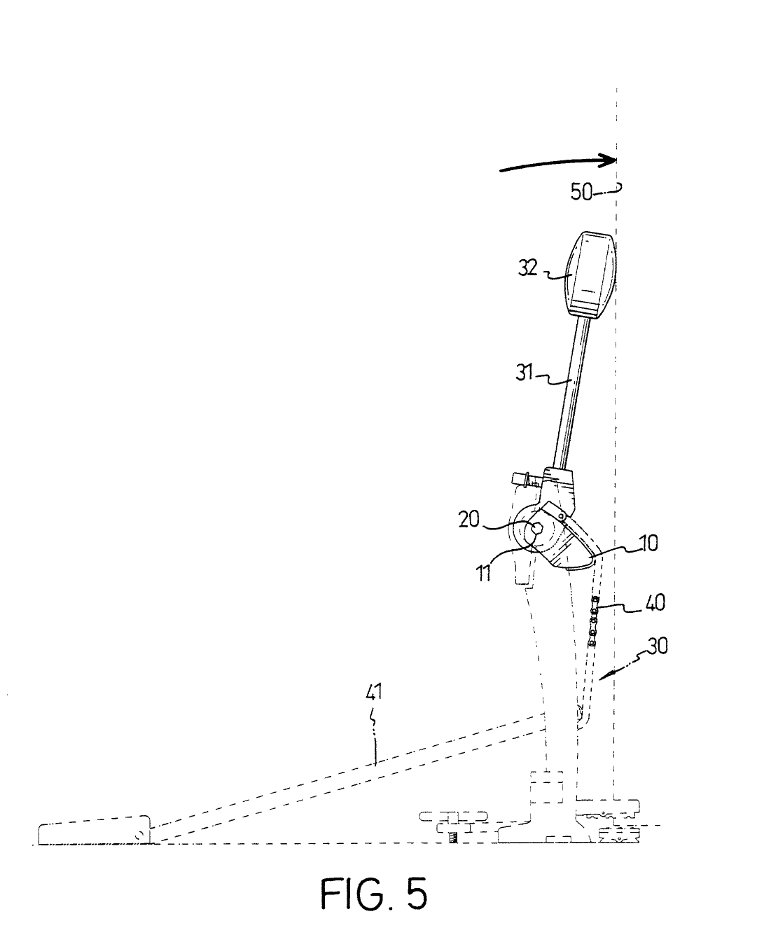

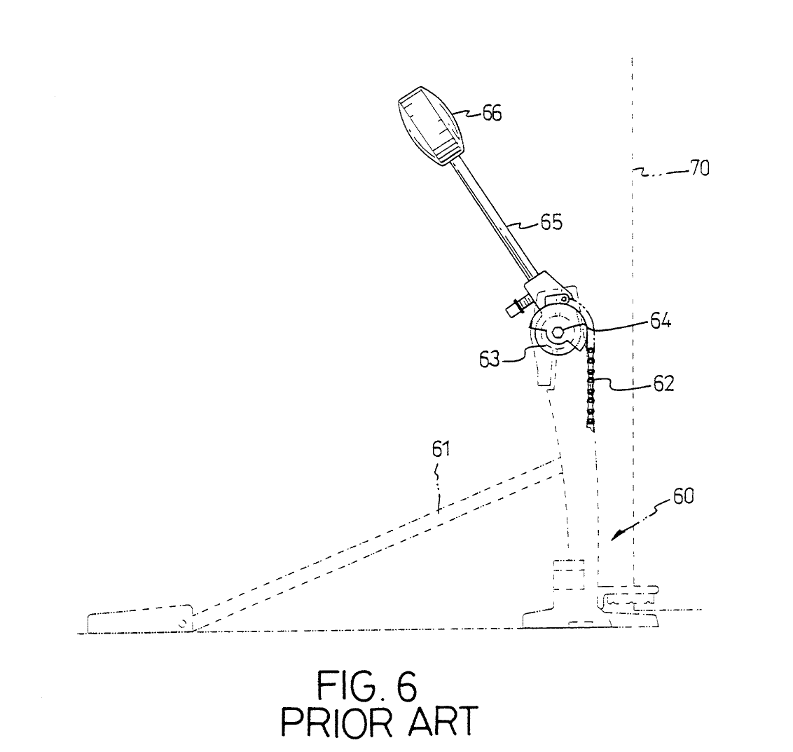

With reference to FIGS. 4 and 5, an operation of the striking mechanism is shown. A player (not shown) steps on the pedal (41) to actuate the striking mechanism to result in the bass drum being impacted. The pedal (41) which being stepped downwardly with a constant force will drive the mallet linkage (10) by a connection of the chain (40), and the mallet (31) mounted on the linkage (10) is consequently driven from a starting position towards the bass drum (50). Because the mallet linkage (10) is eccentrically formed and has the substantially trapezoid side-configuration which results in a varying torque during the strike, the mallet head (32) on the mallet (31) will move and accelerate relative to the constant force input on the pedal (41) to reach the maximum speed just before an impact with the bass drum (50). By doing this, the impact force exerted by the mallet head (32) to the bass drum (50) can be enhanced in comparison to constant input constant speed of the prior art.

Furthermore, when after the mallet head (32) impacts the bass drum (50), the mallet (31) departs from the bass drum (50) and returns to the starting position by the retrieving resilience provided by the resilient member (42). Again, because the mallet linkage (10) is eccentrically formed and has the substantially trapezoid side-configuration which results in a varying force arm, the mallet head (32) on the mallet (31) will move in an accelerated speed relative to constant force input from the resilient member (42) after the impact to quickly depart far enough from the bass drum (50) to be prepared for a subsequent operation. This accelerated return of the mallet head (32) can greatly improve the agility of the mallet (31). Although in the preferred embodiment a bass drum is cited, it is possible that other types of drums will be equally usable with the mallet linkage of the present invention.

From the above description, it is noted that the invention has the following advantages:

1. enhanced impact strength. The mallet head (32) reaches the maximum speed to impact the bass drum (50), and this can enhance the impact force exerted to the bass drum (50) to make a loud sound.

2. improved mallet agility. The mallet (31) departs from the bass drum (50) in the accelerated speed relative to the constant force of the return mechanism and quickly travels a substantial distance to be prepared for the subsequent operation, thus the agility of the mallet (31) is greatly improved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mallet linkage for a bass drum with a striking mechanism having a stand, a shaft pivotally connected to the stand and securely connected to the mallet linkage, a chain connected between the mallet linkage and a pedal so as that the mallet linkage is able to be driven by the pedal, wherein the improvement comprises:
the mallet linkage being a trapezoid and eccentrically connected to the shaft, the mallet linkage having a long side adapted to be connected to the chain and a short side separated from the long side by a joint of the shaft and the mallet linkage, whereby a torque created by the chain to the mallet linkage is able to drive a mallet connected to the mallet linkage.

2. The mallet linkage as claimed in claim 1, wherein the mallet linkage has a through hole defined to correspond to the shaft so that the shaft is able to extend through the through hole and securely engage with the mallet linkage.
